(19) United States
(12) Patent Application Publication
(10) Pub. No.: US 2010/0035719 A1
(43) Pub. Date: Feb. 11, 2010

(54) Epicyclic gearing

(76) Inventor: Sheng Bor Wang, Tapei (TW)

Correspondence Address: SAM CHEN, 7F-1, 293, ROOSEVELT ROAD, SEC 3, TAIPEI, TW

(21) Appl. No.: 12/187,020

(22) Filed: Aug. 6, 2008

(51) Int. Cl. F16H 57/08

(52) U.S. Cl. 475/331

(57) ABSTRACT

An epicyclic gearing includes an annulus comprising a rear bore, an intermediate toothed section, and a stepped front engagement section; a gear assembly comprising front and rear discs, a central hole through the discs, and planet gears rotatably mounted between the discs wherein a portion of the gear assembly is mounted in the toothed section with a rear portion of the teeth of the planet gears meshed with the toothed section; a sun gear comprising outer teeth and having one end passing the bore and the hole to mesh with the teeth of the planet gears; a transmission member comprising a rear ring gear in the engagement section to mesh with a front portion of the teeth of the planet gears and a front drive shaft with a raised key; and a bearing mounted between the ring gear and the engagement section.

### BACKGROUND OF THE INVENTION

1. Field of Invention

The invention relates to epicyclic gearing and more particularly to such an epicyclic gearing system with improved characteristics.

2. Description of Related Art

Epicyclic gearing (also called planetary gearing) is widely employed in transmitting rotational force from one mechanical device to another or gear. It is typical for mounting an epicyclic gearing (i.e., reduction gear) to a motor so that high speed rotation of the motor shaft can be reduced to low speed one for being employed by another device with torque being transmitted.

However, the well known epicyclic gearing systems suffer from several disadvantages including strong vibration, trouble-prone, costly to manufacture, and unreliable in use. Thus, the need for improvement still exists.

### SUMMARY OF THE INVENTION

It is therefore one object of the invention to provide an epicyclic gearing system comprising an annulus comprising a rear central bore, an intermediate toothed section, a front annular engagement section, and a shoulder formed between the toothed section and the engagement section; a gear assembly comprising disc-shaped front and rear plates, a central hole through the front and rear plates, and a plurality of equally spaced apart planet gears each rotatably mounted between the front and rear plates wherein a portion of the gear assembly is mounted in the toothed section with a rear portion of the teeth of the planet gears meshed with the toothed section; a sun gear comprising teeth on an outer surface thereof, the sun gear having one end passing the bore and the hole to mesh with the teeth of the planet gears; a transmission member comprising a rear ring gear disposed in the engagement section to mesh with a front portion of the teeth of the planet gears, a front drive shaft, and a raised key on the outer surface of the drive shaft; and means for reducing friction mounted between the ring gear and the engagement section.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of epicyclic gearing system according to the invention;

FIG. 2 is a sectional view of the epicyclic gearing system; and

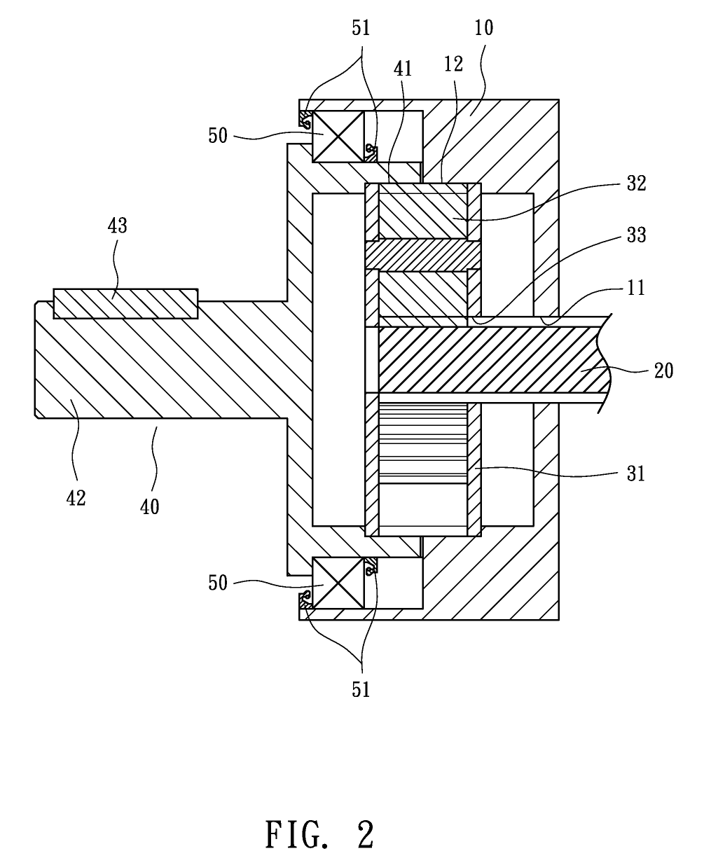

FIG. 3 is a sectional view of FIG. 2.

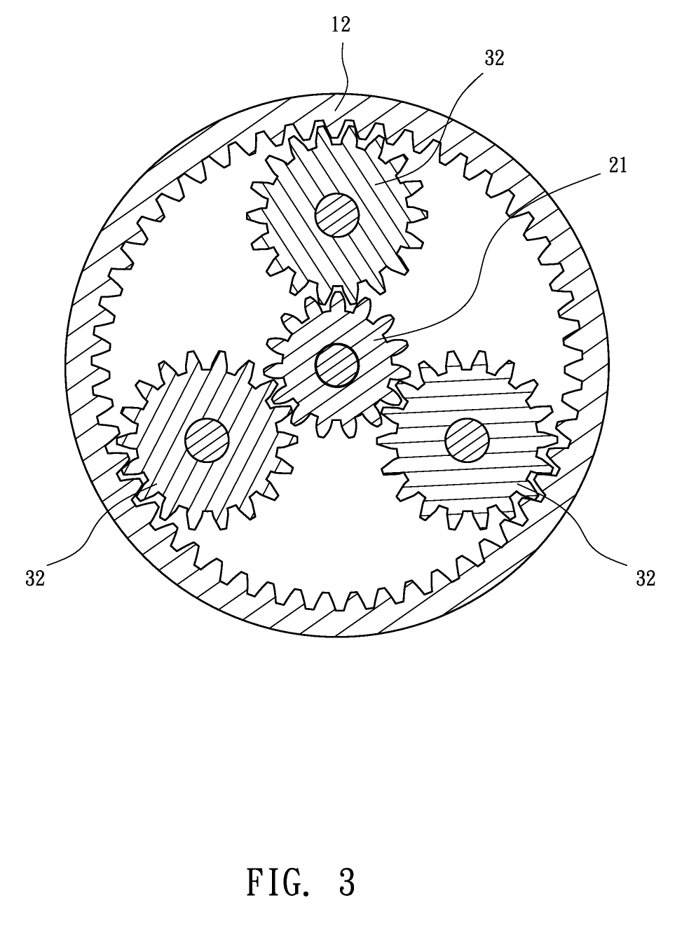

### DETAILED DESCRIPTION OF THE INVENTION

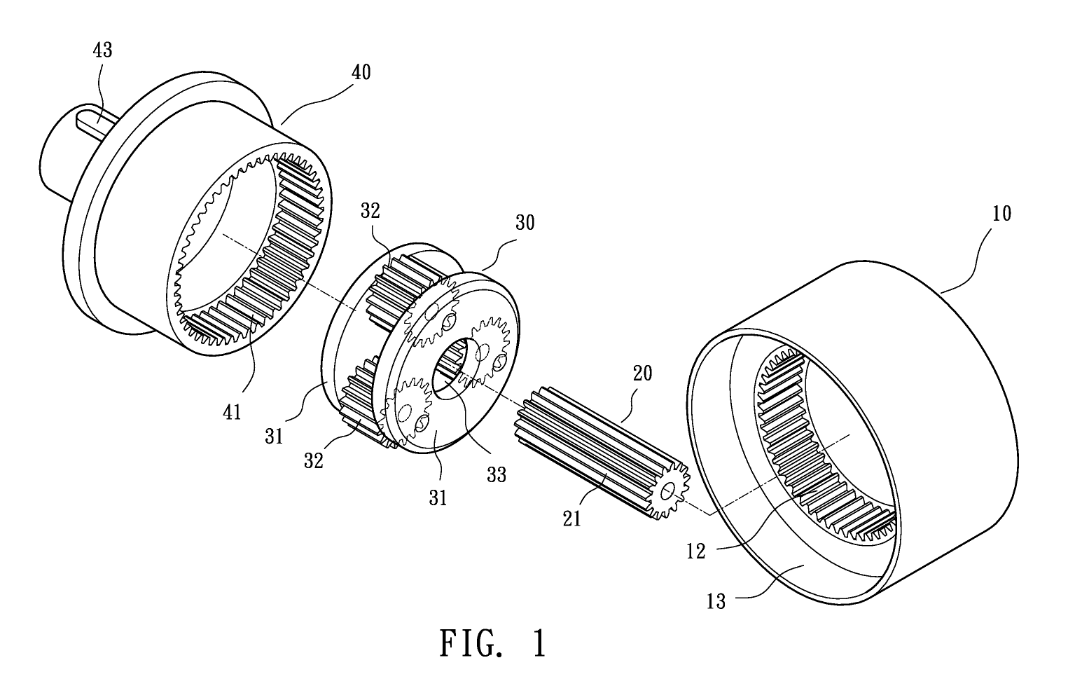

Referring to FIG. 1, an epicyclic gearing system in accordance with a preferred embodiment of the invention comprises the following components as discussed in detail below.

An annulus (i.e., outer ring gear) 10 comprises a rear central bore 11, an intermediate toothed section 12 spaced from the bore 11, and a front annular engagement section 13 adjacent the toothed section 12 with a shoulder (not numbered) formed therebetween.

A gear assembly 30 comprises disc-shaped front and rear plates 31, a central hole 33 through the front and rear plates 31, and three equally spaced apart planet gears 31 each rotatably mounted between the front and rear plates 31. A rear portion of the gear assembly 30 is mounted in the toothed section 12 with a rear portion of the teeth of the planet gears 31 meshed with the toothed section 12.

A shaft-like sun gear 20 has teeth 21 on its outer surface. The sun gear 20 has one end connected to, for example, a driving shaft of a motor (not shown) and the other end passing the bore 11 and the hole 33 to mesh with the teeth of the planet gears 31 and terminating at the hole 33 in the front plate 31.

A transmission member 40 comprises a rear ring gear 41 disposed in the engagement section 13 to mesh with a front portion of the teeth of the planet gears 31, a front drive shaft 42, and a raised key 43 on the outer surface of the drive shaft 42.

A bearing 50 is mounted between the ring gear 41 and the engagement section 13. Finally, a front C-ring 51 is securely engaged between a front edge of the engagement section 13 and the bearing 50 and a rear C-ring 51 is securely put on the ring gear 41 to urge against the bearing 50.

The diameter of the toothed section 12 is the same as that of the ring gear 41 but the number of teeth of the toothed section 12 is different from that of the ring gear 41. It is envisaged by the epicyclic gearing system of the invention that the high rotational speed of the motor shaft can be reduced to a predetermined rotational speed of the transmission member 40 with rotational force and torque being transmitted. Moreover, the force and torque transmission is done a reliable, smooth way.

While the invention herein disclosed has been described by means of specific embodiments, numerous modifications and variations could be made thereto by those skilled in the art without departing from the scope and spirit of the invention set forth in the claims.

What is claimed is:

1. An epicyclic gearing system comprising:
an annulus comprising a rear central bore, an intermediate toothed section, a front annular engagement section, and a shoulder formed between the toothed section and the engagement section;
a gear assembly comprising disc-shaped front and rear plates, a central hole through the front and rear plates, and a plurality of equally spaced apart planet gears each rotatably mounted between the front and rear plates wherein a portion of the gear assembly is mounted in the toothed section with a rear portion of the teeth of the planet gears meshed with the toothed section;
a sun gear comprising teeth on an outer surface thereof, the sun gear having one end passing the bore and the hole to mesh with the teeth of the planet gears;
a transmission member comprising a rear ring gear disposed in the engagement section to mesh with a front portion of the teeth of the planet gears, a front drive shaft, and a raised key on the outer surface of the drive shaft; and
means for reducing friction mounted between the ring gear and the engagement section.

2. The epicyclic gearing system of claim 1, wherein the diameter of the toothed section is equal to that of the ring gear.

3. The epicyclic gearing system of claim 1, wherein the number of the teeth of the toothed section is different from that of the ring gear.

4. The epicyclic gearing system of claim 1, wherein the means for reducing friction comprises a bearing mounted between the ring gear and the engagement section, a front C-rings securely engaged between a front edge of the engagement section and the bearing, and a rear C-ring securely put on the ring gear to urge against the bearing.

5. The epicyclic gearing system of claim 1, wherein the number of the planet gears is three.
